(19) United States
(12) Patent Application Publication
(10) Pub. No.: US 2016/0017117 A1
(43) Pub. Date: Jan. 21, 2016

(54) SUSPENSION OF INORGANIC MATERIAL IN PHOSPHATE ESTER, A FLAME RETARDED THERMOPLASTIC COMPOSITION CONTAINING THE SAME

(71) Applicant: ICL-IP AMERICA INC., Ardsley, NY (US)

(72) Inventors: Meyrav Abecassis WOLFOVICH, Meitar (IL); Smadar HINI, Meitar (IL); Sergei V. LEVCHIK, Croton-on-Hudson, NY (US); Paul MOY, Fishkill, NY (US)

(21) Appl. No.: 14/772,223

(22) PCT Filed: Feb. 21, 2014
(86) PCT No.: PCT/US14/17739

§ 371 Date: Sep. 2, 2015

Related U.S. Application Data
(60) Provisional application No. 61/804,274, filed on Mar. 22, 2013.

(51) Int. Cl. C08K 5/06; C08L 9/06; C08L 67/04; C08L 69/00; C08K 5/523; C08K 3/26

(52) U.S. Cl. CPC C08K 5/06; C08K 5/523; C08K 3/26; C08L 67/04; C08L 69/00; C08L 9/06; C08K 2003/267

(57) ABSTRACT

There is provided herein a stable suspension of at least one of an inorganic oxide, an inorganic hydroxide, an inorganic carbonate and mixed salts thereof of the metals of groups II and III of the Periodic Table of Elements in a liquid phosphate ester. There is also provided a flame retarded thermoplastic resin composition containing a hydrolysis-susceptible thermoplastic resin and the stable suspension. There is also provided an electronic component comprising the flame retarded thermoplastic resin composition.

This application claims priority from U.S. Provisional application No. 61/804,274 Filed on Mar. 22, 2013.

### FIELD OF THE INVENTION

This disclosure herein relates to a stable suspension of at least one of an inorganic oxide, an inorganic hydroxide, an inorganic carbonate and mixed salts thereof in a phosphate ester, which provides stabilization effect to the said phosphate ester against hydrolysis. More specifically this invention relates to a stable suspension in a liquid phosphate ester of inorganic oxide or inorganic hydroxide or inorganic carbonate or mixed salts thereof of the metals of groups II and III of the Periodic Table of Elements. This invention also relates to a flame-retarded thermoplastic composition containing a thermoplastic resin and the stabilized suspension, and to electronic component(s) containing the flame-retarded thermoplastic composition.

### BACKGROUND OF THE INVENTION

Liquid aromatic phosphate esters are widely used as halogen-free, flame retardants for addition to engineering plastics, e.g., polycarbonate or polycarbonate/acrylonitrile-butadiene-styrene blends or polycarbonate/pol(butylene terephthalate) bends or similar. A disadvantage associated with using liquid aromatic phosphate esters, such as, resorcinol bis(diphenyl phosphate) is their tendency to hydrolyze.

The acidic species formed by this hydrolysis can attack the acid susceptible polycarbonate which leads to a decrease of the molecular weight of the polycarbonate and as a result, a decrease of its physical properties. A second adverse affect that accompanies the formation of hydrolysis decomposition products of the phosphate esters is migration of the hydrolyzed additive to the surface of molded parts, e.g., molded electronic parts. This migration is commonly referred to as “juicing.” The results of juicing by the hydrolysis decomposition products include cracks on the surface of the molded part, e.g., molded electronic part, and damage to the tool used to mold the part.

It is known that some inorganic additives can react with phosphorus based acidic species thus neutralizing them and decreasing the overall acidity of the phosphate ester. However the use of the aforementioned inorganic additives is problematic because they undesirably sediment to the bottom of the containers or tanks where the liquid phosphate esters are stored. It is also known that inorganic additives can be added to a flame retarded resin composition during compounding as acid scavenges. This application is limited in its approach due to the poor distribution of the inorganic additives in the resin, and as result, limited contact of the acid scavenging additive with the phosphate ester.

In the view of these problems it would be desirable to provide a stable dispersion of inorganic additives in a liquid phosphate ester which can be stored or transported or pumped into an extruder without separation.

### BRIEF DESCRIPTION OF THE INVENTION

The inventors herein have unexpectedly discovered a stable suspension of at least one of an inorganic oxide, an inorganic hydroxide, an inorganic carbonate and mixed salts thereof of the metals of groups II and III of the Periodic Table of Elements in a liquid phosphate ester. The stable suspension stabilizes the phosphate ester against hydrolysis and thus, reduces the acidic byproducts of the phosphate ester. There is also provided a flame retarded thermoplastic composition that comprises one or more thermoplastic resins that are susceptible to hydrolysis, specifically, polycarbonate and its blends, and acrylonitrile-butadiene-styrene (ABS) copolymer, in combination with the stable suspension described herein. There are also provided electronic components comprising the flame retarded thermoplastic composition.

### DETAILED DESCRIPTION OF THE INVENTION

In one embodiment herein it will be understood that the expression “stable suspension” will comprise a suspension exhibiting little or no change in physical appearance, such as visible sedimentation or gelling for a period of at least 14 days of continuous, undisturbed storage at a temperature of from 20 to about 60° C.

In one embodiment herein there is provided a stable suspension of an inorganic oxide, an inorganic hydroxide, an inorganic carbonate and mixed salts thereof of the metals of groups II and III of the Periodic Table of Elements in a liquid aromatic phosphate ester, which provides for stabilization of the phosphate ester against hydrolysis and provides acid scavenging properties thereto. Further in keeping with the invention, there is provided a flame retarded thermoplastic composition comprising at least one hydrolysis-susceptible thermoplastic resin, and at least one acidity-reducing amount of at least one of an inorganic oxide, an inorganic hydroxide, an inorganic carbonate and mixed salts thereof of the metals of groups II and III of the Periodic Table of Elements suspended in a flame retardant effective amount of a liquid phosphate ester.

More specifically this invention relates to a flame retarded polycarbonate or polycarbonate blend containing a stable suspension of at least one of an inorganic oxide, and inorganic hydroxide, and inorganic carbonate or mixed salts thereof of the metals of groups II and III of the Periodic Table of Elements in a liquid phosphate ester.

The liquid phosphate ester employed herein is, in one embodiment, represented by the following formula (I):

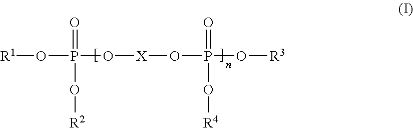

wherein R¹, R², R³ and R⁴ are each independently selected from the group consisting of an aryl or an alkaryl group containing from 6 to about 12 carbon atoms, X is an arylene or bisphenylene group containing from 6 to about 18 carbon atoms. The phosphate may be a low molecular weight phosphate such as a monophosphate wherein n is 0 and as such will typically have a molecular weight less than about 500. The phosphate may also contain an oligomeric phosphate wherein n has an average value of from 0 to 5 in which case the weight average molecular weight the phosphate is at least about 500 and more specifically about 500 to about 2000 measured at 25 degrees Celsius. Alternatively, the phosphate can be a mixture of any of the phosphates described herein. Mixtures of monophosphates with higher molecular weights phosphates are especially useful for balancing physical properties such as melt viscosity and heat deflection temperature of the thermoplastic compositions described herein.

In the above formula (I) for the phosphates of the invention, the aryl groups may be aryl or an alkyl substituted aryl group (i.e. alkaryl group) containing from about 6 to about 12 carbon atoms. More specifically, the aryl groups are independently selected from phenyl, cresyl, xylyl, propylphenyl and butylphenyl groups. The arylene or bisphenylene group is derived from a dihydric compound and is more specifically resorcinol, hydroquinone or bisphenol-A. The aryl groups (R¹, R², R³ and R⁴) are more specifically phenyl. In the case of the oligomeric phosphates, the more specific liquid phosphate ester is resorcinol bis(diphenyl phosphate) wherein n is from 1 to about 5, with diphosphate with n=1 being the main component of the mixture, X is resorcinol and each of the R groups is phenyl.

The phosphate ester will be present in the stable suspension in an amount of from about 80 to about 99.9 weight percent, more specifically from about 85 to about 99.9 weight percent and most specifically from about 90.00 to about 99.98 weight percent based on the weight of the stable suspension.

In one non-limiting embodiment, the at least one of an inorganic oxide, and inorganic hydroxide, and inorganic carbonate or mixed salts thereof of the metals of groups II and III of the Periodic Table of Elements can include the simple oxides, hydroxides and carbonates of the metals of the groups II and III, as well as mixed compounds such as the hydroxycarbonates of one or more of the metals of groups II and III of the Periodic Table.

In one non-limiting embodiment some examples the at least one of an inorganic oxide, and inorganic hydroxide, and inorganic carbonate or mixed salts thereof of the metals of groups II and III of the Periodic Table of Elements are selected from the group consisting of Mg(OH)₂, MgO, Al₂O₃, Al(OH)₃, MgCO₃, (MgOH)₂CO₃, CaCO₃, ZnO, ZnCO₃ and mixtures thereof.

The mixed salt of the stable suspension herein may be at least one hydrotalcite which reduces the acidity of the phosphate ester(s). Some examples are synthetic or natural hydrotalcites of the general formula (II):

M²⁺₍₁₋ₓ₎M³⁺ₓ(OH)₂Aⁿ_{x/2}mH₂O (II)

wherein M²⁺ is a divalent metal ion, more specifically, Mg²⁺, M³⁺ is a trivalent metal ion, more specifically, Al³⁺, Aⁿ is an n-valent anion, more specifically, CO₃²⁻ or SO₄²⁻, n is an integer greater than 0, more specifically 2, x is 0 to 0.5, more specifically 0 to 0.33, and m>0, more specifically >0.5.

Suitable hydrotalcites include hydrous or anhydrous basic carbonates of magnesium, calcium, zinc, aluminum, bismuth. These hydrotalcites can be natural or synthetic. Examples of natural hydrotalcites include one represented by the general formula Mg₆Al₂(OH)₁₆CO₃ 4H₂O. Examples of synthetic hydrotalcites include Mg_{0.7}Al_{0.3}(OH)₂(CO₃)_{0.15} 0.5H₂O, Mg_{4.5}Al₂(OH)₁₃CO₃ 3.5H₂O, Mg_{4.2}Al₂(OH)_{12.4}CO₃ 4H₂O, Mg_{4.3}Al₂(OH)_{12.6}CO₃ 4H₂O, Zn₆Al₂(OH)₁₆CO₃ 4H₂O, Ca₆Al₂(OH)₁₆CO₃ 4H₂O, and Mg₁₄Bi₂(OH)_{29.6} 4.2H₂O.

The inorganic agents which are particularly suitable for the suspension are Mg(OH)₂ and the hydrotalcites described herein.

For a more proper dispersion and formation of an even more stable suspension, the oxides, hydroxides, carbonates or mixed metal salts will have particle median particle size of D₅₀ of less than 3 microns and more specifically, less than 2 microns and 99% of all particles will have a diameter D₉₉ of less than 8 microns and more specifically, less than 5 microns.

The stable suspension can contain in on embodiment from about 0.01 wt. % to about 5 wt. % of the oxides, hydroxides, carbonates or mixed salts and more specifically from about 0.2 to about 1.5 wt. % of the oxides, hydroxides, carbonates or mixed salts, based on the total weight of the stable suspension.

In order to be able to incorporate solids into liquid media, high mechanical forces are necessary. Dispersants are used herein in order to lower the dispersing forces needed and in order to minimize the total input into the system of energy needed to deflocculate the particulate solids during formulation preparation. The dispersants used herein are surface-active substances of anionic, cationic or neutral structure. These substances, in a small amount, are either applied directly to the inorganic solid or added to the dispersing medium (i.e., the phosphate ester).

Suitable anionic dispersants include but are not limited to: potassium laurate, sodium lauryl sulfate, sodium dodecylsulfate, alkyl polyoxyethylene sulfates, sodium alginate, dioctyl sodium sulfosuccinate, phosphatidyl glycerol, phosphatidic acid and their salts, glyceryl esters, sodium carboxymethylcellulose, cholic acid and other bile acids (e.g., cholic acid, deoxycholic acid, glycocholic acid, taurocholic acid, glycodeoxycholic acid) and salts thereof (e.g., sodium deoxycholate, etc.).

Suitable cationic dispersants include but are not limited to quaternary ammonium compounds, such as benzalkonium chloride, cetyltrimethylammonium bromide, lauryldimethylbenzylammonium chloride, acyl camitine hydrochlorides, or alkyl pyridinium halides.

Suitable nonionic dispersants include: polyoxyethylene fatty alcohol ethers, polyoxyethylene sorbitan fatty acid esters, polyoxyethylene fatty acid esters, sorbitan esters, glycerol monostearate, polyethylene glycols, polypropylene glycols, cetyl alcohol, cetostearyl alcohol, stearyl alcohol, aryl alkyl polyether alcohols, polyoxyethylene-polyoxypropylene copolymers, polaxamines, methylcellulose, hydroxycellulose, hydroxy propylcellulose, hydroxy propylmethylcellulose, noncrystalline cellulose, polysaccharides including starch and starch derivatives such as hydroxyethylstarch, polyvinyl alcohol, and polyvinylpyrrolidone. In a more specific embodiment the nonionic surfactant is a polyoxyethylene and polyoxypropylene copolymer and preferably a block copolymer of propylene glycol and ethylene glycol. Among polyoxyethylene fatty acid esters are included those having short alkyl chains of less than 6 carbon atoms, specifically less than 4 carbon atoms.

The most specific dispersants herein include a nonionic modified polyether dispersant available from Evonik under the trade name Tegomer DA 646 and nonionic block copolymer of polyhydroxystearic acid and polyethylene glycol available from Huntsman under the trade name Tersperse 2510 or mixtures thereof.

The stable suspension of the present invention contains from about 0.01 to about 5 wt. % of the dispersant and more specifically from about 0.1 to about 2 wt. % the dispersant.

The dispersion of the oxides, hydroxides, carbonates or mixed salts in liquid phosphate ester can be prepared by using different high shear mixers or ultrasound techniques. The list of most common, but not limited to techniques is dissolver stirrers, high-shear rotor/stator (HSM) mixer, ultrahigh-shear inline mixer (UHSM)

In one non-limiting embodiment, before the addition of the oxides, hydroxides, carbonates or mixed salts to the liquid phosphate ester, the dispersing agent is added and mixed with the liquid phosphate ester using a conventional mechanical or magnetic stirrer. In an alternative embodiment, the oxides, hydroxides, carbonates or mixed salts can be added to the liquid phosphate ester and mixed, followed by addition and mixing of the dispersing agent thereto. In yet another embodiment, the dispersing agent can be added to the oxides, hydroxides, carbonates or mixed salts and mixed, followed by addition and mixing of the liquid phosphate ester.

In one specific embodiment herein the dispersant or mixture thereof can be added to the phosphate ester with application of mixing for about 30 minutes, e.g., using a four bladed propeller Teflon stirrer at about 630 rpm (rotations per minute), the stirrer can then be replaced with a rotor-stator ultra-disperser, and after less than a minute the inorganic particles can be added and the dispersion process continued at about 10,600 rpm for about 10 minutes and then at an increased speed of about 12,600 rpm for an additional 10 minutes.

In another embodiment herein there is provided a flame retarded thermoplastic resin composition comprising the hydrolysis stabilized phosphate ester stable suspension of the oxides, hydroxides, carbonates or mixed salts described herein and thermoplastic resin, e.g., a hydrolysis susceptible thermoplastic resin. More specifically this invention relates to a flame retarded thermoplastic composition comprising a polycarbonate or polycarbonate blend and the stable suspension of inorganic oxide, inorganic hydroxide, inorganic carbonate or mixed salts thereof of the metals of groups II and III of the Periodic Table of Elements described herein.

The flame retarded thermoplastic composition herein can comprise thermoplastic resins such as those thermoplastic resins having susceptibility to degradation by hydrolysis and to blends, or alloys, containing one or more of such resins. In particular, the flame-retarded thermoplastic composition will contain an effective flame-retardant amounts of the stable suspension described herein and hydrolysis-susceptible resins such as polyesters, e.g., alkylene polyesters of terephthalic acid such as polyethylene terephthalate, polybutylene terephthalate, poly-1,4-cyclohexane-dimethylene terephthalate, or polyamides, e.g. polyamide-6, polyamide-6,6, polyamide-11, polyamide-12, polyamide-4,6, polyamide-6,10 and polyamide-6,12, as well as polyamides prepared from terephthalic acid and/or isophthalic acid and trimethylhexamethylenediamine; polyamides prepared from adipic acid and m-xylylenediamines; polyamides prepared from adipic acid, azelaic acid, and 2,2-bis-(p-aminocyclohexyl) propane, and polyamides prepared from terephthalic acid and 4,4′-diaminodicyclohexylmethane and the like, and especially the polycarbonates and blends thereof with styrene graft copolymer resin.

Aromatic polycarbonate resins are known compounds and the properties and methods of making polycarbonate resins are also known. Typically these are prepared by reacting a dihydric phenol with a carbonate precursor, such as phosgene, a haloformate or a carbonate ester and generally in the presence of an acid acceptor and a molecular weight regulator. The more specific polycarbonate resin used herein for the flame retarded thermoplastic composition is bisphenol A polycarbonate.

Another thermoplastic resin that may be employed is styrene graft copolymer resin. The graft copolymer resin is preferably a graft copolymer resin comprising a rubbery polymeric substrate and a rigid syrene superstrate. In a more specific embodiment, the graft copolymer comprises more than 30% by weight rubbery polymeric substrate to styrene superstrate. The graft copolymer resin may also be used in combination with various block copolymer resins, such as, for example, polystyrene-polybutadiene diblock, triblock, or larger multi-block copolymer resins, polystyrene-poly(ethylenebutylene) diblock, triblock, or larger multi-block copolymer resins, and polystyrene-poly(ethylene-propylene) diblock, triblock, or larger multi-block copolymer resins, as well as mixtures of block copolymer resins.

In one specific embodiment herein the styrene graft copolymer can be any one or more of an ABS resin (acrylonitrile/butadiene/styrene copolymer), an AES resin (acrylonitrile/ethylene/propylene/styrene copolymer), an ACS resin (acrylonitrile/chlorinated polyethylene/styrene copolymer), or an AAS resin (acrylonitrile/acrylic elastomer/styrene copolymer).

In one specific embodiment the ratio between polycarbonate and the styrene graft copolymer can be from about 50:50 to about 95:5. In more specific embodiment the ratio is from 70:30 to 90:10.

In one embodiment, the flame retarded thermoplastic resin composition can contain the thermoplastic resin in an amount of from about 60 to about 99 weight percent, more specifically from about 75 to about 97 weight percent and most specifically from about 85 to about 96 weight percent, said weight percents being based on the total weight of the flame retarded thermoplastic composition.

In one embodiment the flame retarded thermoplastic resin composition can contain the stable suspension in an amount of from about 1 to about 40 weight percent, more specifically from about 3 to about 25 weight percent and most specifically from about 4 to about 15 weight percent, said weight percents being based on the total weight of the flame retarded thermoplastic composition.

In one embodiment, the stable suspension of oxides, hydroxides, carbonates or mixed salts in a phosphate ester, can be added to a polycarbonate/styrene graft copolymer blend during extrusion. Known techniques of metering pumping of viscous liquids into one of heating zones of extruder are used.

In one embodiment, the amount of the stable suspension component to be added to the thermoplastic resin will depend on the ratio of polycarbonate/styrene graft copolymer. The higher concentration of the polycarbonate the lower loading of stable suspension is required to achieve flame retardant effect and pass for example the UL-94 V-0 test. The amount of phosphate ester thereof can vary from about 1 to about 40, more specifically from about 3 to about 25, and more specifically from about 4 to about 15 weight percent of the total weight of the flame retarded thermoplastic composition.

The flame retarded composition herein optionally contains a tetrafluoroethylene polymer, also referred to as PTFE, as antidripping agent. Suitable tetrafluoroethylene polymers for use in this invention typically have a fibril structure which tends to stabilize the polymer under molten conditions. The PTFE can be added to the thermoplastic resin composition as a direct solid or as a concentrate with a resin such as polycarbonate or SAN. Typically PTFE is added at the level from about 0.01 to about 2.0 but more specifically from about 0.1 to about 0.5 weight percent of the total weight of flame retarded thermoplastic composition.

In addition the flame retarded thermoplastic composition herein, can contain one or more other additives in known and conventional amounts, e.g., antioxidants, UV stabilizers, plasticizers, fillers, reinforcements, pigments, colorants, other flame retardants, and the like, as is well known to those skilled in the art.

In order that those skilled in the art will be better able to practice the invention, the following examples are given by way of illustration and not by way of limitation.

### EXAMPLES

### Preparation of Stable Suspension

### Example 1

396.8 g of resorcinol bis(diphenyl phosphate) (Fyrolflex RDP, ex. ICL-IP) was added to a polyethylene (PE) beaker. 1.2 g of modified polyether dispersant (Tegomer DA 646, Evonik) was added to the beaker and a four bladed propeller Teflon stirrer was set up at 630 rpm for 30 minutes. After the initial mixing the stirrer was replaced in a Rotor-stator ultra-dispersor T-25 digital ultra-turrax (IKA) with dispersing element S25N-25F which was set up to low speed of 3,400 rpm. The disperser was run for less than one minute and then 2 g of hydrotalcite (HTC) of d₅₀=1.2 micron (Hycite 713, ex. BASF) was added and the dispersing speed was increased to 10,600 rpm for 10 minutes and then increased to 12,600 rpm for additional 10 minutes. A uniform dispersion was observed. The dispersion was transferred to a glass jar. No sedimentation of the material at the bottom of glass jar was noticed. Long term stability of the dispersion was assessed by an accelerated aging method by heating the suspension in an oven at 54° C. for 14 days. No visual separation or precipitation was observed. The sample was also kept at −20° C. in a refrigerator for two weeks and no difference in the flowability compared to an equivalent sample kept at room temperature was detected. In addition no phase separation was detected at these temperatures.

### Example 2

194.3 g of resorcinol bis(diphenyl phosphate) (Fyrolflex RDP, ex. ICL-IP) was added to a PE beaker. 1.35 g of modified polyether dispersant (Tegomer DA 646, Evonik) and 1.35 of nonionic block copolymer of polyhydroxystearic acid and polyethylene glycol dispersant (Tersperse 2510, Huntsman) were added to the beaker and a four bladed propeller Teflon stirrer was set up at 630 rpm for 30 minutes. After the initial mixing the stirrer was replaced in a Rotor-stator ultra-dispersor T-25 digital ultra-turrax (IKA) with a dispersing element S25N-25F which was set up to a low speed of 3,400 rpm. The disperser was run for less than one minute and then 3 g of magnesium hydroxide (MDH) of d50=1.3 micron (FR-20-100D-S10AGrade, ex. ICL-IP) was added and the dispersing speed was for increased to 10,600 rpm for 10 minutes and then further increased to 12,600 rpm for an additional 10 minutes. A uniform dispersion was observed. The dispersion was transferred to a glass jar. No sedimentation of the material at the bottom of Vessel glass jar was noticed. Long term stability of the dispersion was assessed by an accelerated aging method by heating the suspension in an oven at 54° C. for 14 days. No separation or precipitation was observed. The sample was also kept at −20° C. for two weeks and no difference in the flowability compare to an equivalent sample kept at room temperature was detected. In addition no phase separation was detected at these temperatures.

### Example 3

196.2 g of resorcinol bis(diphenyl phosphate) (Fyrolflex RDP, ex. ICL-IP) was added to a PE beaker. 0.9 g of modified polyether dispersant (Tegomer DA 646, Evonik) and 0.9 of nonionic block copolymer of polyhydroxystearic acid and polyethylene glycol dispersant (Tersperse 2510, Huntsman) were added to the beaker and a four bladed propeller Teflon stirrer was set up at 630 rpm for 30 minutes. After the initial mixing the stirrer was replaced in a Rotor-stator ultra-dispersor T-25 digital ultra-turrax (IKA) with a dispersing element S25N-25F which was set up to a low speed of 3,400 rpm. The disperser was run for less than one minute and then 1 g of magnesium hydroxide (MDH) of d50=1.3 micron (FR-20-100D-S10AGrade, ex. ICL-IP) and 1 g of hydrotalcite (HTC) of d50=1.2 micron (Hycite 713, ex. BASF) were added and the dispersing speed was increased to 10,600 rpm for 10 minutes and further increased to 12,600 rpm for an additional 10 minutes. A uniform dispersion was observed. The dispersion was transferred to a glass jar. No sedimentation of the material at the bottom of Vessel glass jar was noticed. Long term stability of the dispersion was assessed by an accelerated aging method by heating the suspension in an oven at 54° C. for 14 days. No separation or precipitation was observed. The sample was also kept at −20° C. for two weeks and no difference in the flowability compared to an equivalent sample kept at room temperature was detected. In addition no phase separation was detected at these temperatures.

### Examples 4-7

Examples 1-3 were repeated with variation of concentration of inorganic ingredient and dispersants. The composition of the various stable suspensions of Examples 1-7 are shown in Table 1.

TABLE 1
Composition of dispersions Examples 1-7

| | Composition, wt. % | | | | | | |
|---|---|---|---|---|---|---|---|
| | Ex. 1 | Ex. 2 | Ex. 3 | Ex. 4 | Ex. 5 | Ex. 6 | Ex. 7 |
| RDP | 99.2 | 97.15 | 98.1 | 98.1 | 98.1 | 97.15 | 97.15 |
| HTC | 0.5 | | 0.5 | | 1.0 | 1.5 | 0.75 |
| MDH | | 1.5 | 0.5 | 1.0 | | | 0.75 |
| Tegomer DA | 0.3 | 0.675 | 0.45 | 0.45 | 0.45 | 0.675 | 0.675 |
| 646 | | | | | | | |
| Tersperse 2510 | | 0.675 | 0.45 | 0.45 | 0.45 | 0.675 | 0.675 |

### Comparative Example 1, Examples 8-14

Comparative Example 1 and Examples 8-14 were prepared in the same manner. The polycarbonate resin (Lexan 141, ex. Sabic) and ABS resin (C8707 ex. Sabic) was pre-dried prior to the extrusion. The two resins and a RDP (Comparative example 1) or stable suspension (Examples 8-14) were thoroughly mixed in the proportions shown in Table 2 using a bowl mixer. The pre-mixed flame retarded compositions were slowly forced-fed into the extruder hopper. The extrusion was performed at 180°-250° C. using a conical twin screw co-rotating L/D=32 Brabender Plasti-Corder extruder. The extruded composites were cooled in water tray and pelletized, and dried of excess moisture in forced air ovens for at least six hours at 60° C. Test specimens were prepared by injection molding the pellets of compounded mixtures on Arburg All-Rounder Injection Molding machine at 210-265° C.

The hydrolytic stability of the flame retarded compositions of Comparative example 1 and Examples 8-14 were evaluated by measuring the retained molecular weight of polycarbonate after various periods of exposure to high humidity at elevated temperature. About 3 ml of de-ionized water was placed into sealable vials. A wad of glass fibers was placed above the water to separate pellets from the direct contact with water. Identical amounts of the flame retarded composition in the form of pellets of substantially uniform dimensions were placed on the top of the glass fiber wad. The vials were sealed and then heated to 107° C. for 0, 30, 90 and 192 hours.

Thereafter, the pellets were removed from the vials and extracted with acetone to isolate the polycarbonate which was then analyzed by GPC (gel permeation chromatography using chloroform) for determining the molecular weight.

Flammability of the molded specimens of the flame retarded compositions was tested on 1.6 mm thickness bars following the UL-94 vertical burning protocol using an Atlas Chamber. Tensile and flexural strength was measured on Instron instrument following ISO 527 and ISO 178 respectively. Izod Impact strength was measured using a Pendulum Impact Tester following ISO 180.

TABLE 2
Compositions, hydrolytic stability, flammability and physical properties of flame
retardant compositions.

| | Composition, wt. % | | | | | | | |
|---|---|---|---|---|---|---|---|---|
| | Comp. | | | | | | | |
| | ex. 1 | Ex. 8 | Ex. 9 | Ex. 10 | Ex. 11 | Ex. 12 | Ex. 13 | Ex. 14 |
| PC | 72.9 | 72.9 | 72.9 | 72.9 | 72.9 | 72.9 | 72.9 | 72.9 |
| ABS | 18.2 | 18.2 | 18.2 | 18.2 | 18.2 | 18.2 | 18.2 | 18.2 |
| RDP | 9.0 | | | | | | | |
| Suspension Ex. 1 | | 9.0 | | | | | | |
| Ex. 2 | | | 9.0 | | | | | |
| Ex. 3 | | | | 9.0 | | | | |
| Ex. 4 | | | | | 9.0 | | | |
| Ex. 5 | | | | | | 9.0 | | |
| Ex. 6 | | | | | | | 9.0 | |
| Ex. 7 | | | | | | | | 9.0 |
| Retain of Mw of PC, % | | | | | | | | |
| 0 hours | 100 | 100 | 100 | 100 | 100 | 100 | 100 | 100 |
| 30 hours | 93 | 96 | 97 | 98 | 98 | 99 | 96 | 99 |
| 90 hours | 59 | 78 | 88 | 79 | 85 | 74 | 81 | 84 |
| 192 hours | 21 | 50 | 68 | 64 | 67 | 53 | 62 | 73 |
| UL-94, 1.6 mm | V-0 | | V-1 | V-0 | V-2 | V-1 | V-1 | V-0 |
| Tensile strength, MPa | 54.1 | | 53.4 | 53.6 | 53.7 | 53.4 | 53.4 | 53.8 |
| Flexural | | | | | | | | |
| Strength, MPa | 8.8 | | 10.4 | 10.0 | 10.9 | 10.6 | 9.7 | 9.5 |
| Modulus, MPa | 2400 | | 3100 | 2800 | 3200 | 3100 | 2700 | 2900 |
| Izod impact, J/m | 615 | | 610 | 658 | 693 | 693 | 614 | 631 |

As Table 2 shows the flame retarded composition based on regular grade of RDP retains only 21% of the original weight of polycarbonate after exposure to high temperature and moisture for 192 hours. In contrast the flame retarded composition with stable suspensions of MDH or HTC or mixtures thereof retained from 50 to 73% of the original molecular weight of polycarbonate.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention but that the invention will include all embodiments falling within the scope of the appended claims.

1. A stable suspension of at least one of an inorganic oxide, an inorganic hydroxide, an inorganic carbonate and mixed salts thereof of the metals of groups II and III of the Periodic Table of Elements in a liquid phosphate ester.

2. The stable suspension of claim 1 comprising:
a. from 90 to 99.98 wt. % of at least one liquid phosphate ester;
b. from 0.01 to 5 wt. % of at least one of an inorganic oxide, an inorganic hydroxide, an inorganic carbonate and mixed salts thereof; and,
c. from 0.01 to 5% of at least one dispersant

3. The stable suspension of claim 1 wherein phosphate ester is represented by the general formula (I): 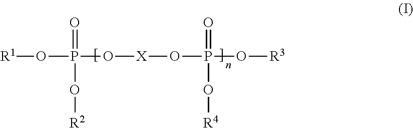
wherein R¹, R², R³ and R⁴ are each independently selected from the group consisting of an aryl or an alkaryl group containing from 6 to about 12 carbon atoms, X is an arylene or bisphenylene group of from 6 to about 18 carbon atoms, and n is from 0 to 5.

4. The stable suspension of claim 1 wherein the inorganic oxide, inorganic hydroxide, or inorganic carbonate are selected from the group consisting of Mg(OH)₂, MgO, Al₂O₃, Al(OH)₃, MgCO₃, (MgOH)₂CO₃, CaCO₃, ZnO, ZnCO₃ and mixtures thereof.

5. The stable suspension of claim 1 wherein the mixed salt is natural or synthetic hydrotalcite represented by the general formula (II):
M²⁺₍₁₋ₓ₎M³⁺ₓ(OH)₂Aⁿ_{x/2}mH₂O (II)
wherein M²⁺ is a divalent metal ion, M³⁺ is a trivalent metal ion, Aⁿ is an n-valent anion, n is an number greater than 0, preferably 2, x is 0 to 0.5, preferably 0 to 0.33, and m>0.

6. The stable suspension of claim 1 further comprising at least one of a cationic, anionic or nonionicdispersant.

7. The stable suspension of claim 6 wherein the dispersant is selected from a nonionic modified polyether dispersant or nonionic block copolymer of polyhydroxystearic acid and polyethylene glycol or mixtures thereof.

8. A flame retarded thermoplastic resin composition comprising a hydrolysis-susceptible thermoplastic resin and the stabilized dispersion of claim 1.

9. The flame retarded thermoplastic resin composition of claim 8, wherein thermoplastic resin is a polycarbonate or a polycarbonate blend.

10. The flame retarded polycarbonate resin composition of claim 9, whereas the thermoplastic resin is a polycarbonate/acrylonitrile-butadiene-styrene blend.

11. An electronic component comprising the flame retarded thermoplastic resin composition of claim 8.

12. An electronic component comprising the flame retarded thermoplastic resin composition of claim 9.

13. An electronic component comprising the flame retarded thermoplastic resin composition of claim 10.
